(19) United States
(12) Patent Application Publication
(10) Pub. No.: US 2024/0359403 A1
(43) Pub. Date: Oct. 31, 2024

(54) SUPERSATURATED COLLOIDAL GEL THREE-DIMENSIONAL (3D) PRINTING OF HIGH-PERFORMANCE VITRIMERS

(71) Applicant: ATSP Innovations, LLC, Houston, TX (US)

(72) Inventors: Louis O. Vaught, Tulsa, OK (US); Andreas A. Polycarpou, Tulsa, OK (US); Saifur Rahman, Houston, TX (US)

(73) Assignee: ATSP Innovations, LLC, Houston, TX (US)

(21) Appl. No.: 18/654,030

(22) Filed: May 3, 2024

Related U.S. Application Data
(60) Provisional application No. 63/498,737, filed on Apr. 27, 2023.

(51) Int. Cl. B29C 64/194; B29C 64/106; B29C 64/209; B29C 64/314; B29K 67/00; B29K 101/10; B29K 105/00; B29K 105/16; B33Y 10/00; B33Y 30/00; B33Y 70/00

(52) U.S. Cl. CPC B29C 64/194; B29C 64/106; B29C 64/209; B29C 64/314; B33Y 10/00; B33Y 30/00; B33Y 70/00; B29K 2067/00; B29K 2101/10; B29K 2105/0014; B29K 2105/0032; B29K 2105/16

(57) ABSTRACT

A novel technology to create 3D-printed objects that are extremely temperature resistant, mechanically robust, ultra-low-wear, and exhibit self-healing behavior. The material can be manufactured in a wide variety of process conditions and even used as a high-strength adhesive, enabling hybrid fabrication strategies. The gel precursor for this material is formed from two solids that react to create a high-performance polymer when heated. Unlike similar materials, these are solid at room temperature and form a printable gel when dissolved in a solvent. Addition of a secondary solvent to this gel modifies the solubility and creates a super-saturated fluid with tunable rheology. Once the gel material has been printed, it is allowed to dry via forced convection. This removes the solvent and leaves only the uncured polymer precursors. After the majority of the solvent has been removed, the material is heated to its cure temperature, at which point it melts, cures, and re-hardens. This process is then repeated for each subsequent layer deposited.

### CROSS REFERENCE TO RELATED APPLICATIONS

This applications claims the benefit of U.S. Provisional Application 63/498,737 filed Apr. 27, 2023.

### BACKGROUND OF THE INVENTION

3D printing with high-performance polymers is challenging for a variety of reasons. The most popular methods involve melting thermoplastic powders or filaments to fuse them together, however, high-performance materials have poor melt behavior and/or extremely high melting temperatures, making this approach both challenging and limited in practice. In particular, printed high-performance thermoplastics undergo large temperature-related deformations as they cool off during printing, which is often referred to as “warping.” Many high-performance materials also require annealing post-print to improve material properties, which may lead to further loss of geometric accuracy. An alternative approach is to extrude a thermosetting material in liquid or gel form and cure it on demand, which makes the material much easier to work with prior to being cured. However, this approach is not generally used for high-performance materials due to a lack of control over material properties and resultant limitations to material performance.

“Vitrimers” are a type of thermosetting polymers that have self-healing behavior when heated past a certain threshold. This self-healing behavior allows for high-strength fusion of the material post-cure, as well as extremely reliable fusion between cured and uncured material. This behavior enables high-performance 3D printing using a progressive deposition and cure, without the negative consequences seen in traditional polymers.

However, a major unsolved issue exists regarding the use of gel extrusion to manufacture high-performance materials. When the materials are cured via heating, they almost always become less viscous and are at risk of “slumping” and changing shape. This is generally corrected with particulate additives, which is an undesirable approach. The amount of additive required to control the shape of a high-performance vitrimer during curing is excessive, and can be as high as 30% of the material by volume. This negatively impacts the mechanical properties of the printed material and limits the kinds and amounts of beneficial fillers that can be used. The process proposed herein addresses these limitations.

### BRIEF DESCRIPTION OF FIGURES

To obtain a better understanding of the invention, reference is made to the accompanying drawings illustrating the invention in which:

FIG. 1 is a novel process of 3D Printing in accordance with one embodiment of the invention;

FIG. 2 is a (a) Prototype: Modified Commercial Gel Printer; (b) 3D printing steps; and

FIG. 3 is a series of ATSP Layered samples of increasing volume in side-by-side orientation

### DESCRIPTION OF THE INVENTION

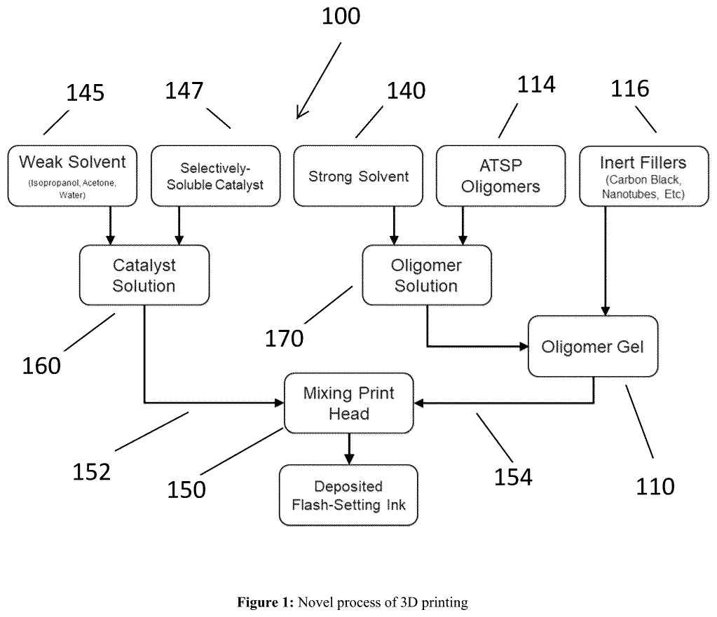

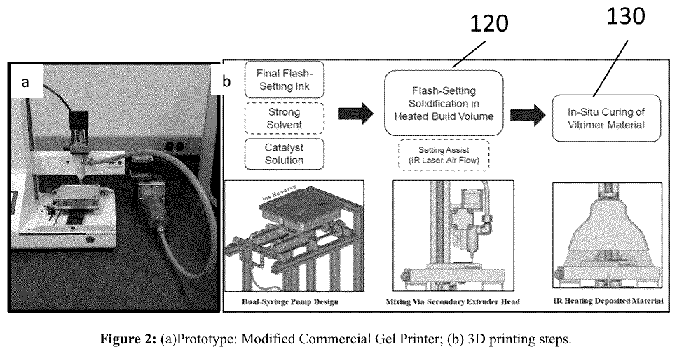

FIGS. 1 and 2 show the novel 3D printing technology 100. This novel technology hardens and cures a gel material in order to create 3D-printed objects that are extremely temperature resistant (up to 400° C.), mechanically robust, ultra-low-wear, and exhibit self-healing behavior. This curing is performed in two phases: an initial evaporative flash-setting of a gel precursor material into a hard uncured layer 120, and a subsequent in-situ infrared cure of the solidified layer 130.

The gel precursor 110, shown as the “Oligomer Gel” in FIG. 1 is formed from two solids that react to create a high-performance polymer when heated, labeled as “ATSP Oligomers” 114 in FIG. 1. Unlike similar materials, these are solid at room temperature, but form an easily-printable gel when dissolved in a strong solvent. The deposition of a solvent-based gel is critically enabling for this technology, as the material can be mixed at relatively low viscosity and deposited in thin layers. During subsequent stages of the process, the material will develop gaseous byproducts, and the deposition of thin layers allows these to rapidly diffuse from the material, rather than forming bubbles and creating a foam.

Once the gel material has been printed, it is dried via forced convection. This removes the solvent gently and leaves only the uncured polymer precursors. Again, removal of the solvent is key for preventing foaming during subsequent stages. After the majority of the solvent has been removed, the material is heated to its cure temperature, at which point it melts, cures, and re-hardens into the final high-performance vitrimer. This process is then repeated for each subsequent layer deposited. Unlike similar high-performance polymers, the use of a self-healing vitrimer with dynamic covalent bonds enables complete cure between layers.

In order to allow the uncured gel material to flow when needed but also harden when needed, a combination of strong solvents 140 and weak solvents 145, typically NMP and isopropyl alcohol, are used to form the as-deposited material, so that the uncured materials only partially dissolve in the solution. As shown in FIG. 1, these solvents actively are blended by the mixing head 150 to allow for dynamic control over material viscosity. The behavior of the material as it is placed can be modified by varying the ratio of each solvent used and the ratio of this solvent blend to the solid material. Therefore, the strong and weak solvents must be introduced into the printing process through at least two separate feed mechanisms (152 and 154) and mixed prior to extrusion, such that their ratio can be modulated. This allows direct control of both the amount of solid and liquid in the material and the rate at which the material solidifies when placed, which allows for dramatic changes in how the material flows during the printing process.

Aromatic Thermosetting co-Polyester (ATSP), shown in FIG. 1 as the ATSP Oligomers 114, is an example vitrimer, which is a thermosetting polymer that exhibits a covalent adaptive network under specific environmental conditions, usually elevated temperature and the presence of an activating chemical. The 3D printing process consists of 3 necessary material components: any precursor materials which are reacted to form the polymer, a strong solvent (NMP) which may dissolve the precursors, and a weak solvent (Acetone) which only wets out the materials but does not dissolve them. To achieve property modification on the fly with decreased complexity, two solutions are created: a Catalyst Solution 160 and an Oligomer Solution 170. These are blended together in real time by a machine-controlled feed system. The primary component is a “strong solvent” mixture formulated with a high concentration of uncured polymer precursor. This is diluted by the printing system during extrusion with a “weak solvent” solution which is primarily weak solvent (75% typ.), mixed with strong solvent (25% typ.).

Particulate or liquid additives may optionally be added to the precursor materials to modulate material properties, such as lubricant powders like PTFE, pigments to change the rate of infrared light (IR) absorption, or catalysts which are soluble in the solvents, but these additives are not necessary to the fundamental process and are used at significantly lower volume fractions than traditional gel extrusion methods (5% versus 20%). Examples of these additives are shown in FIG. 1 as the “selectively-soluble catalyst” 147 and “inert fillers” 116 and in this example process are added separately to each blended feed material to allow for modulation. However, these may be introduced at any stage of the process prior to deposition.

This invention overcomes the requirement of using inert fillers by using the uncured oligomer itself as the particulate filler. Strong and weak solvents are blended to make a supersaturated solution that the oligomer drops out of as a suspended particulate. By varying the ratio of solvent to oligomer using multiple feeds, the amount of particulate loading can be varied on the fly.

Since the solution is already supersaturated, it begins solidifying as soon as it is placed, creating a “snap-hardening” condition as the solvent flashes off. This is only desirable when the material is being placed; when the material is being pumped through the nozzle it could cause jamming, and so the ability to tune the solvent concentration on the fly using separate material feeds avoids print failure. However, the key innovation of the process is the use of supersaturated gel. The weak solvent is preferentially more volatile than the strong solvent, so that it can act as a lubricant during extrusion while rapidly evaporating when placed. This allows for changes in fluid viscosity during the pumping and extrusion process that are semi-independent of the rate at which the material hardens after being extruded.

Utilizing this selectively-solvated material with tunable viscosity, printing of high-performance vitrimer materials can be performed reliably and repeatably, due to having several degrees of freedom and the ability to change material properties on the fly. High-performance vitrimers are particularly desirable as durable conformal coatings or thicker structures. These may be used to shield components, to prevent wear, to ablatively insulate materials against high temperatures, to decrease friction, or to protect against corrosion. Being able to apply these additively and via an automated process would be extremely desirable, as the coatings would be cheaper to apply, more flexible in terms of material properties, and of arbitrary thickness. This technology would be useful for applications where complex and repairable high-performance coatings are needed, such as turbomachinery, aerospace structures, space structures, or oil and gas equipment.

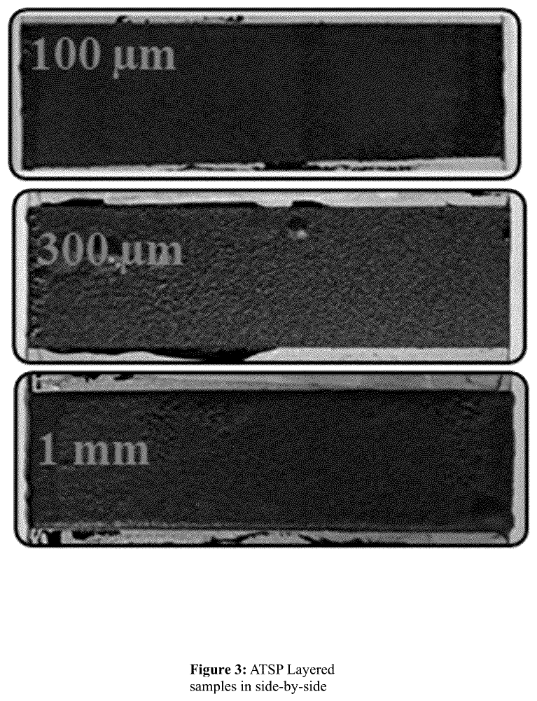

High-performance vitrimers are also desirable for production of bulk components or parts that must be extremely durable or need frequent repairs. This is due to their self-healing and high-strength adhesive behavior. FIG. 3 shows an example 3D printed and cured coupon of ATSP vitrimer. Using this method, high-durability, predictable parts can be 3D printed into a net shape, and these parts can then be adhered to other parts via self-healing after the 3D printing process is complete. This can also be used to 3D print parts directly onto an existing structure, which is extremely valuable for situations in which field repairs must be performed. Examples of this are generally remote or hostile conditions, such as warzones, space exploration, offshore drilling, nuclear plants, disaster relief, and icebreaking.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A 3D printing method for creating temperature-resistant, low-wear, self-healing objects, comprising:
forming a gel precursor from two solids that react to create a high-performance polymer when heated;
dissolving the gel precursor in a strong solvent to form a printable gel;
depositing the printable gel in thin layers using a dynamic control over material viscosity;
drying the printed gel via forced convection to remove the solvent;
heating the dried gel to its cure temperature to melt, cure, and re-harden it into a high-performance vitrimer; and
repeating the process for each subsequent layer deposited.

2. The method of claim 1, wherein the gel precursor is an aromatic thermosetting co-polyester (ATSP) forming a vitrimer with dynamic covalent bonds.

3. The method of claim 1, further comprising:
blending strong and weak solvents to form the as-deposited material; and
introducing the solvents into the printing process through separate feed mechanisms and mixing prior to extrusion to control the flow and solidification rate of the material.

4. The method of claim 3, wherein
the strong solvent is mixed with a high concentration of uncured polymer precursor to form an Oligomer solution, and the weak solvent is mixed with a soluble catalyst to form a Catalyst solution, and wherein the two solutions are blended together in real time by the feed mechanism at a ratio of about 75% weak solvent to about 25% strong solvent.

5. The method of claim 3, wherein the strong solvent mixture is diluted with the weak solvent solution during extrusion, allowing for direct control over the amount of solid and liquid in the material.

6. The method of claim 1, further comprising:
adding particulate or liquid additives, such as lubricant powders, pigments, or catalysts, to modulate material properties; and
introducing the additives at any stage of the process prior to deposition.

7. A 3D printing system for implementing the method of claim 1, comprising:
a mixing head for blending strong and weak solvents to control material viscosity; and
machine-controlled feed systems for introducing the solvents and precursor materials.

8. A high-performance vitrimer produced by the method of claim 1, suitable for use as a durable coating, high-strength adhesive, or bulk component in applications such as turbomachinery, aerospace structures, or oil and gas equipment.

9. A 3D printing system for creating temperature-resistant, low-wear, self-healing objects, comprising:
a material preparation unit configured to form a gel precursor from two solids that react to create a high-performance polymer when heated;
a solvent blending unit configured to dissolve the gel precursor in a strong solvent to form a printable gel;
a deposition unit configured to deposit the printable gel in thin layers using dynamic control over material viscosity;
a drying unit configured to dry the printed gel via forced convection to remove the solvent;
a heating unit configured to heat the dried gel to its cure temperature to melt, cure, and re-harden it into a high-performance vitrimer; and
a control unit configured to repeat the process for each subsequent layer deposited.

10. The 3D printing system of claim 9, wherein the gel precursor is an aromatic thermosetting co-polyester (ATSP) forming a vitrimer with dynamic covalent bonds.

11. The 3D printing system of claim 9, further comprising:
a solvent blending mechanism configured to blend strong and weak solvents, such as NMP and isopropyl alcohol, to form the as-deposited material; and
separate feed mechanisms for introducing the solvents into the printing process and mixing them prior to extrusion to control the material's flow and solidification rate.

12. The 3D printing system of claim 10, wherein the strong solvent mixture is diluted with the weak solvent solution during extrusion, allowing for direct control over the amount of solid and liquid in the material.

12. The 3D printing system of claim 9, further comprising:
an additive introduction unit configured to add particulate or liquid additives, such as lubricant powders, pigments, or catalysts, to modulate material properties at any stage of the process prior to deposition.
